(19) United States
(12) Patent Application Publication
(10) Pub. No.: US 2018/0281286 A1
(43) Pub. Date: Oct. 4, 2018

(54) FILTERING TEMPERATURE DISTRIBUTION DATA OF BUILD MATERIAL

(71) Applicant: HEWLETT-PACKARD DEVELOPMENT COMPANY, L.P., Houston, TX (US)

(72) Inventors: Xavier Vilajosana, Sant Cugat del Valles (ES); Pol Fornos, Barcelona (ES); David Ramirez Muela, Barcelona (ES); Sergio Puigardeu Aramendia, Barcelona (ES); Alejandro Manuel De Pena, Barcelona (ES)

(73) Assignee: HEWLETT-PACKARD DEVELOPMENT COMPANY, L.P., Houston, TX (US)

(21) Appl. No.: 15/568,125

(22) PCT Filed: Aug. 20, 2015
(86) PCT No.: PCT/US2015/046020

§ 371 Date: Oct. 20, 2017

(51) Int. Cl. B29C 64/393; B33Y 10/00; B33Y 30/00; B33Y 50/02; B29C 64/165

(52) U.S. Cl. CPC B29C 64/393; B33Y 10/00; B29C 64/264; B33Y 50/02; B29C 64/165; B33Y 30/00

(57) ABSTRACT

Temperatures of a layer of build material on a support member may be detected. Each of the temperatures corresponding to a respective area of the layer. Based on data representing the three-dimensional object, a subset of the temperatures may be filtered from spatial temperature distribution data comprising the temperatures. A degree of heat or energy applied to the layer may be controlled based on the filtered spatial temperature distribution data.

### BACKGROUND

Additive manufacturing systems may generate three-dimensional objects on a layer-by-layer basis. The quality of objects produced by such systems may vary widely depending on the type of additive manufacturing technology used. For example, the quality of objects may depend on temperature regulation during the build process.

### BRIEF DESCRIPTION

Some examples are described with respect to the following figures:

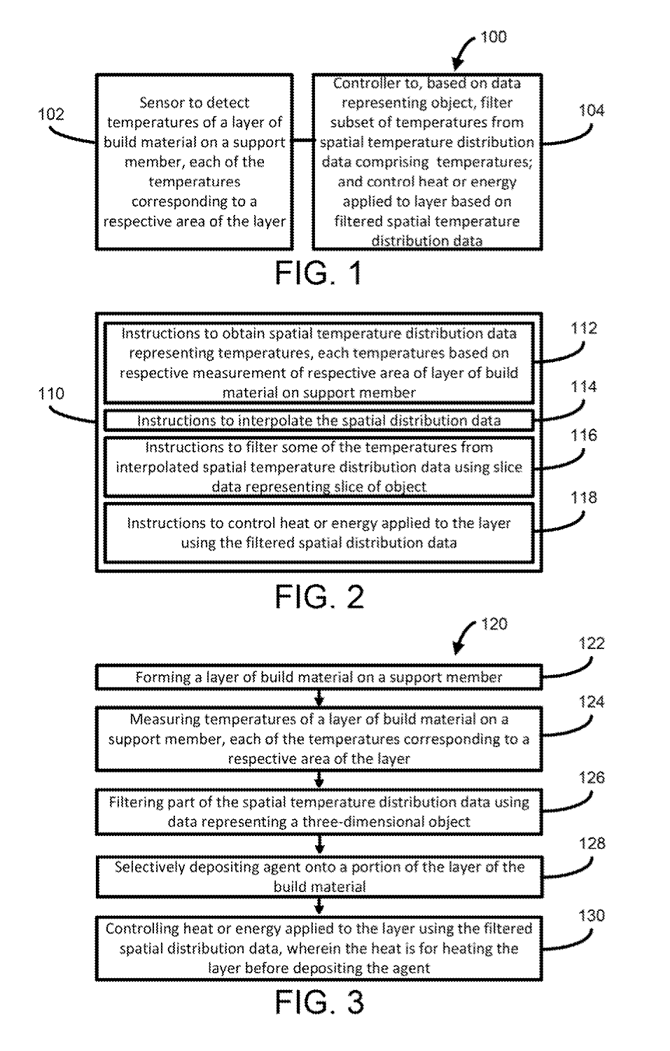

FIG. 1 is a block diagram illustrating a system for generating a three-dimensional object according to some examples;

FIG. 2 is a block diagram illustrating a non-transitory computer readable storage medium according to some examples;

FIG. 3 is a flow diagram illustrating a method according to some examples;

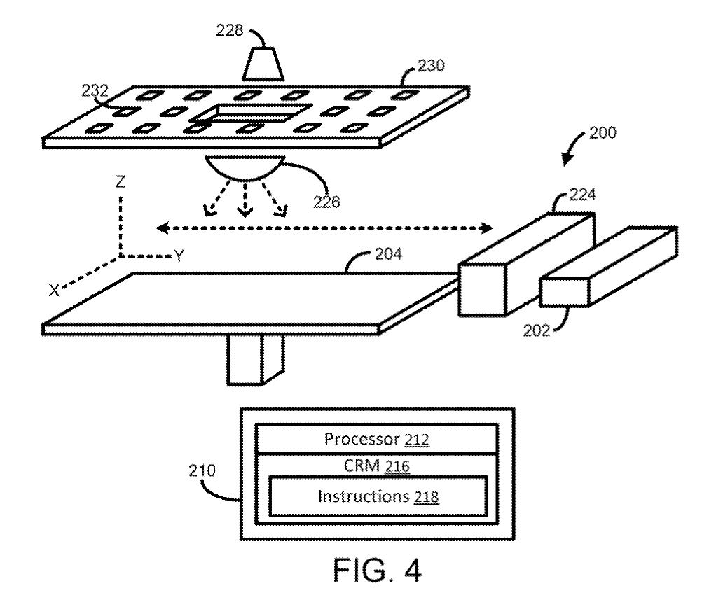

FIG. 4 is a simplified isometric illustration of an additive manufacturing system according to some examples;

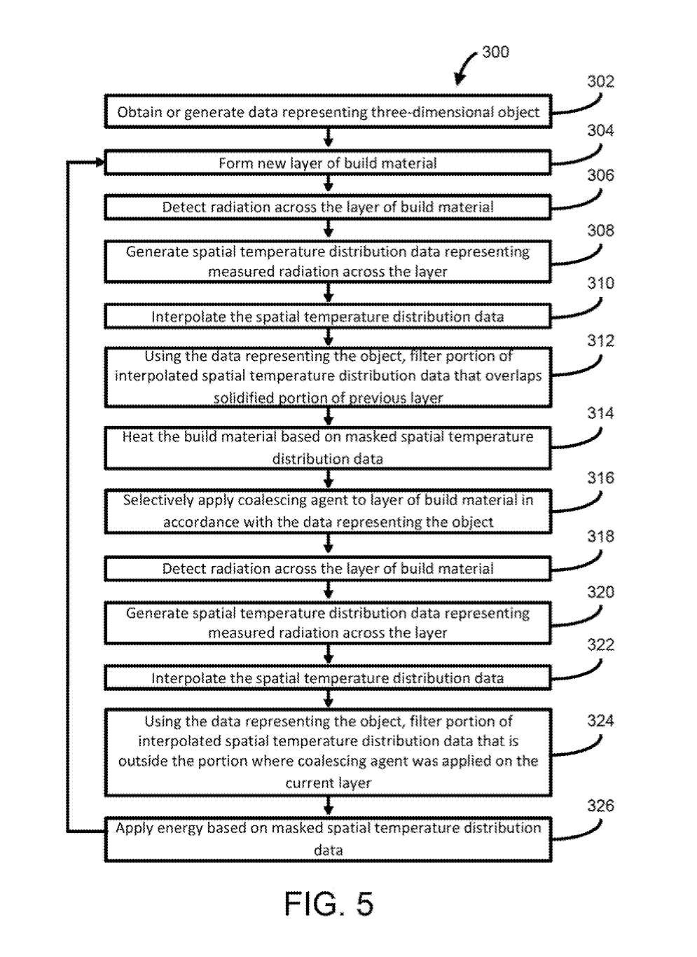

FIG. 5 is a flow diagram illustrating a method of generating a three-dimensional object according to some examples;

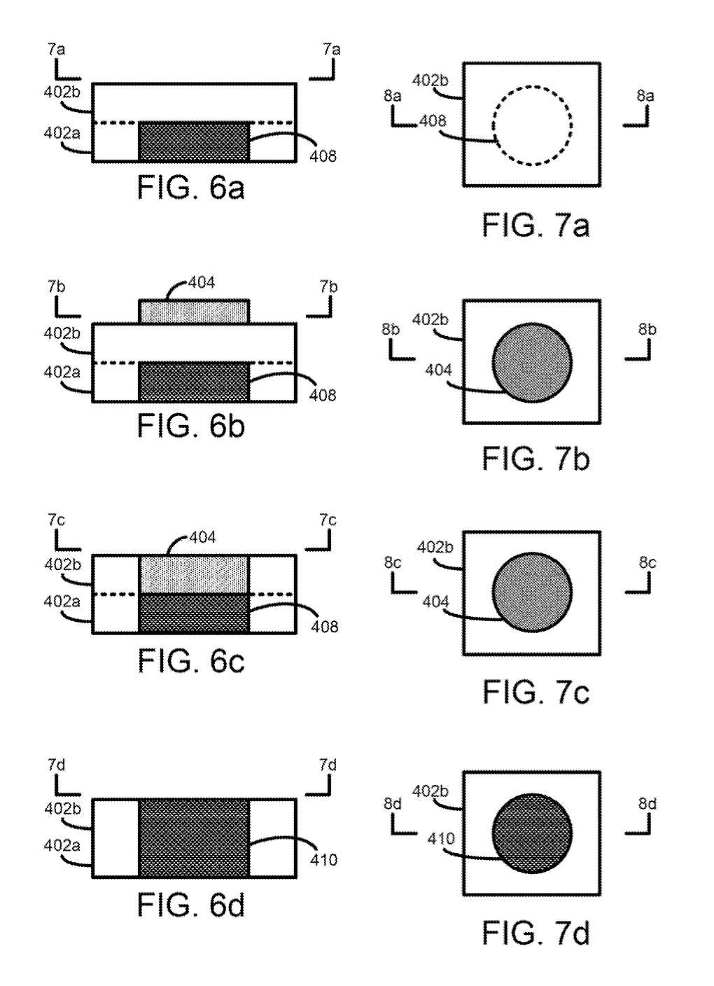

FIGS. 6a-d show a series of cross-sectional side views of layers of build material according to some examples; and

FIGS. 7a-d show a series of top views of layers of build material according to some examples.

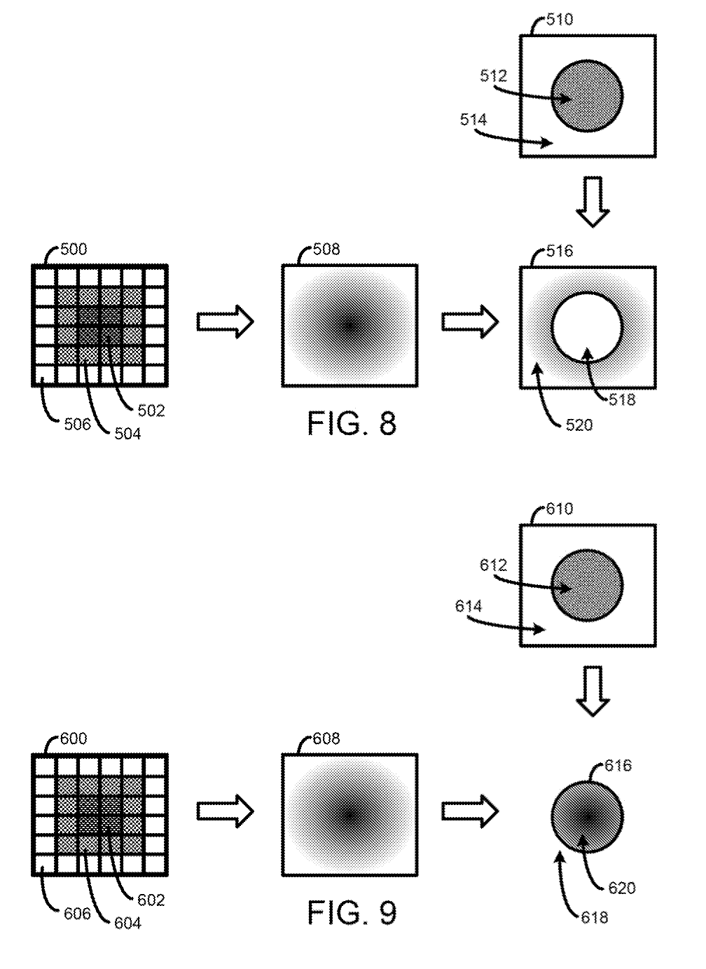

FIGS. 8-9 show processing of temperature distribution data according to some examples.

### DETAILED DESCRIPTION

The following terminology is understood to mean the following when recited by the specification or the claims. The singular forms “a,” “an,” and “the” mean “one or more.” For example, “an agent distributor” means “one or more agent distributors.” The terms “including” and “having” are intended to have the same inclusive meaning as the term “comprising.”

Some additive manufacturing systems generate three-dimensional objects through the solidification of portions of successive layers of build material, such as a powdered or liquid build material. The properties of generated objects may be dependent on the type of build material and the type of solidification mechanism used. In some examples, solidification may be achieved by using an agent distributor to deliver a binder agent which binds and solidifies build material into a binder matrix, which is a mixture of generally separate particles or masses of build material that are adhesively bound together by a binder agent. In other examples, solidification may be achieved by temporary application of energy to the build material. This may, for example, involve use of a coalescing agent (i.e. a fusing agent), which is a material that, when a suitable amount of energy is applied to a combination of build material and coalescing agent, may cause the build material to coalesce and solidify. For example, the coalescing agent may act as an absorber of applied energy such that the portions of build material having coalescing agent experience coalescence and solidification. In some examples, a multiple agent additive manufacturing system may be used such as that described in PCT Application No. PCT/EP2014/040841 filed on Jan. 16, 2014, entitled “GENERATING A THREE-DIMENSIONAL OBJECT”, the entire contents of which are hereby incorporated herein by reference. For example, in addition to selectively delivering coalescing agent to layers of build material, coalescence modifier agent may also be selectively delivered to layers of build material. A coalescence modifier agent (i.e. a detailing agent) may serve to modify the degree of coalescence of a portion of build material on which the coalescence modifier agent has been delivered or has penetrated. In yet other examples, other methods of solidification may be used, for example selective laser sintering (SLS), light polymerization, among others. The examples described herein may be used with any of the above additive manufacturing systems and suitable adaptations thereof.

Object properties may depend on the temperatures of build materials during such processes. Such properties may include, for example, surface roughness, accuracy, and strength. In some examples, energy absorbed by build material on which coalescing agent has been delivered or has penetrated may also propagate into surrounding build material. The energy may be sufficient to cause surrounding build material to heat up. For example, the energy may propagate laterally through the build material, beneath the current layer (uppermost layer), and/or into a future layer once it is applied on the newest layer. A heat reservoir may form beneath the surface of each newly created layer as the new layer is formed. The heat in the reservoir may then propagate laterally across the build material, below the newest layer, and/or into a future layer once it is applied on the newest layer.

Thus, portions of the build material may be heated to a temperature suitable to cause softening and bonding of build material. This temperature could be above or below the material melting point. This may result in the subsequent solidification of portions of the build material that were not intended to be solidified and this effect is referred to herein as coalescence bleed. Coalescence bleed may result, for example, in a reduction in the overall accuracy of generated three-dimensional objects.

Moreover, spatial or temporal temperature gradients in the build material may decrease object accuracy through inhomogeneous contraction of portions of the object because, for example, some build materials may be optimally processed in very narrow temperature windows.

Moreover, achieving optimum object properties may involve achieving different temperature targets on the build material at different phases of the build process.

Accordingly, examples of the present disclosure provide for generating accurate temperature data representing temperature feedback from the build material throughout the build process. The temperature data may be interpolated, and then filtered to remove or ignore temperature data relating to portions of the build material that are less relevant for different phases of the build process, such as after forming a layer of build material, and after delivering coalescing agent on the layer. By removing or ignoring less relevant data for particular phases of the build material, e.g. removing data outside where a slice of an object is to be generated when detecting temperatures after coalescing agent has been delivered, more accurate and relevant temperature data for the phases may be used. Thus, temperatures may be better regulated throughout the build process to more accurately achieve different target temperatures in different phases of the build process. Additionally, the temperatures may be kept within narrow predetermined ranges using heaters and/or energy sources. Thus, target object properties and control of the generation of the three-dimensional object may be achieved, including object shape, control of mechanical properties, and consistency when generating objects built at different times.

FIG. 1 is a block diagram illustrating a system 100 for generating a three-dimensional object according to some examples. The system 100 may include at least one sensor 102 to detect temperatures (e.g. detecting a physical property, such as radiation, associated with a temperature) of a current layer of build material on a support member, each of the temperatures corresponding to a respective area of the current layer. It is understood that a layer “on a support member” encompasses the layer being on at least one previous layer which is on the support member. The system 100 may include a controller 104 to, based on data representing the three-dimensional object, filter a subset of the temperatures from spatial temperature distribution data comprising the temperatures; and control a degree of heat or energy applied to the current layer based on the filtered spatial temperature distribution data. The heat or the energy applied to the current layer may, for example, be uniform across the current layer, or may be variable e.g. different degrees of heat or energy applied to different portions of the current layer. “Filtering” and “filtered” is understood herein to refer to removing at least one temperature value representing at least one area of spatial temperature distribution data, or ignoring the at least one temperature value (e.g. designating the at least one temperature value as not to be used in subsequent operations).

FIG. 2 is a block diagram illustrating a non-transitory computer readable storage medium 110 according to some examples. The non-transitory computer readable storage medium 110 may include instructions 112 that, when executed by a processor, cause the processor to obtain spatial temperature distribution data representing temperatures. Each of the temperatures may be based on a respective measurement of a respective area of the layer of build material on a support member. The build material may be used for generating a three-dimensional object. The non-transitory computer readable storage medium 110 may include instructions 114 that, when executed by a processor, cause the processor to interpolate the spatial distribution data. The non-transitory computer readable storage medium 110 may include instructions 116 that, when executed by a processor, cause the processor to filter some of the temperatures from the interpolated spatial temperature distribution data using slice data representing a slice of the three-dimensional object. The non-transitory computer readable storage medium 110 may include instructions 118 that, when executed by a processor, cause the processor to control heat or energy applied to the layer using the filtered spatial distribution data.

FIG. 3 is a flow diagram illustrating a method 120 according to some examples. At 122, a layer of build material may be formed on a support member. At 124, temperatures of a layer of build material on a support member may be measured. Each of the temperatures may correspond to a respective area of the layer. At 126, part of the spatial temperature distribution data may be filtered using data representing a three-dimensional object. At 128, agent may be selectively deposited onto a portion of the layer of the build material. At 130, heat or energy applied to the layer may be controlled using the filtered spatial distribution data. The heat may be for heating the layer before depositing the agent. The energy may be for causing the portion to coalesce and solidify to form a slice of the three-dimensional object.

FIG. 4 is a simplified isometric illustration of an additive manufacturing system 200 according to some examples. The system 200 may be operated as described further below with reference to the flow diagram of FIG. 5 to generate a three-dimensional object.

In some examples the build material may be a powder-based build material. As used herein the term powder-based materials is intended to encompass both dry and wet powder-based materials, particulate materials, and granular materials. In some examples, the build material may include a mixture of air and solid polymer particles, for example at a ratio of about 40% air and about 60% solid polymer particles. One suitable material may be Nylon 12, which is available, for example, from Sigma-Aldrich Co. LLC. Another suitable Nylon 12 material may be PA 2200 which is available from Electro Optical Systems EOS GmbH. Other examples of suitable build materials may include, for example, powdered metal materials, powdered composite materials, powdered ceramic materials, powdered glass materials, powdered resin material, powdered polymer materials, and the like, and combinations thereof. It should be understood, however, that the examples described herein are not limited to powder-based materials or to any of the materials listed above. In other examples the build material may be in the form of a paste, liquid or a gel. According to one example a suitable build material may be a powdered semi-crystalline thermoplastic material.

The additive manufacturing system 200 may include a system controller 210. Any of the operations and methods disclosed herein (e.g. in FIG. 5) may be implemented and controlled in the additive manufacturing system 200 and/or controller 210. The controller 210, as understood herein, comprises (1) a non-transitory computer-readable storage medium comprising instructions to perform operations and methods disclosed herein, and a processor coupled to the non-transitory computer-readable storage medium to execute the instructions or (2) circuitry to perform the operations and methods disclosed herein.

The controller 210 may include a processor 212 for executing instructions that may implement the methods described herein. The processor 212 may, for example, be a microprocessor, a microcontroller, a programmable gate array, an application specific integrated circuit (ASIC), a computer processor, or the like. The processor 212 may, for example, include multiple cores on a chip, multiple cores across multiple chips, multiple cores across multiple devices, or combinations thereof. In some examples, the processor 212 may include at least one integrated circuit (IC), other control logic, other electronic circuits, or combinations thereof.

The processor 212 may be in communication with a computer-readable storage medium 216, e.g. via a communication bus. The computer-readable storage medium 216 may include a single medium or multiple media. For example, the computer readable storage medium 216 may include one or both of a memory of the ASIC, and a separate memory in the controller 210. The computer readable storage medium 216 may be any electronic, magnetic, optical, or other physical storage device. For example, the computer-readable storage medium 216 may be, for example, random access memory (RAM), static memory, read only memory, an electrically erasable programmable read-only memory (EEPROM), a hard drive, an optical drive, a storage drive, a CD, a DVD, and the like. The computer-readable storage medium 216 may be non-transitory. The computer-readable storage medium 216 may store, encode, or carry computer executable instructions 218 that, when executed by the processor 212, may cause the processor 212 to perform any of the methods or operations disclosed herein according to various examples. In other examples, the controller 210 may not include a computer-readable storage medium 216, and the processor may comprise circuitry to perform any of the methods or operations disclosed herein without executing separate instructions in a computer-readable storage medium.

The system 200 may include a coalescing agent distributor 202 to selectively deliver coalescing agent to successive layers of build material provided on a support member 204. According to one non-limiting example, a suitable coalescing agent may be an ink-type formulation comprising carbon black, such as, for example, the ink formulation commercially known as CM996a available from Hewlett-Packard Company. In one example such an ink may additionally comprise an infra-red light absorber. In one example such an ink may additionally comprise a near infra-red light absorber. In one example such an ink may additionally comprise a visible light absorber. In one example such an ink may additionally comprise a UV light absorber. Examples of inks comprising visible light enhancers are dye based colored ink and pigment based colored ink, such as inks commercially known as CM993A and CE042A available from Hewlett-Packard Company.

The controller 210 may control the selective delivery of coalescing agent to a layer of provided build material in accordance with the instructions 218.

The agent distributor 202 may be a printhead, such as a thermal inkjet printhead or a piezo inkjet printhead. The printhead may have arrays of nozzles. In one example, printheads such as those commonly used in commercially available inkjet printers may be used. In other examples, the agents may be delivered through spray nozzles rather than through printheads. Other delivery mechanisms may be used as well. The agent distributor 202 may be used to selectively deliver, e.g. deposit, coalescing agent when in the form of suitable fluids such as a liquid.

The coalescing agent distributor 202 may include a supply of coalescing agent or may be connectable to a separate supply of coalescing agent.

The agent distributor 202 may be used to selectively deliver, e.g. deposit, coalescing agent when in the form of a suitable fluid such as liquid. In some examples, the agent distributor 202 may have an array of nozzles through which the agent distributor 202 is able to selectively eject drops of fluid. In some examples, each drop may be in the order of about 10 pico liters (pl) per drop, although in other examples the agent distributor 202 is able to deliver a higher or lower drop size. In some examples the agent distributor 202 is able to deliver variable size drops.

In some examples the coalescing agent may comprise a liquid carrier, such as water or any other suitable solvent or dispersant, to enable it to be delivered via a printhead.

In some examples the printhead may be a drop-on-demand printhead. In other examples the printhead may be a continuous drop printhead.

In some examples, the agent distributor 202 may be an integral part of the system 200. In some examples, the agent distributor 202 may be user replaceable, in which case they may be removably insertable into a suitable agent distributor receiver or interface module of the system 200.

In the example illustrated in FIG. 2, the agent distributor 202 may have a length that enables it to span the whole width of the support member 204 in a so-called page-wide array configuration. In one example this may be achieved through a suitable arrangement of multiple printheads. In other examples a single printhead having an array of nozzles having a length to enable them to span the width of the support member 204 may be used. In other examples, the agent distributor 202 may have a shorter length that does not enable it to span the whole width of the support member 204.

The agent distributor 202 may be mounted on a moveable carriage to enable it to move bi-directionally across the length of the support 204 along the illustrated y-axis. This enables selective delivery of coalescing agent across the whole width and length of the support 204 in a single pass. In other examples the agent distributor 202 may be fixed, and the support member 204 may move relative to the agent distributor 202.

In other examples the agent distributors may be fixed, and the support member 204 may move relative to the agent distributors.

It should be noted that the term ‘width’ used herein is used to generally denote the shortest dimension in the plane parallel to the x and y axes illustrated in FIG. 2, whilst the term ‘length’ used herein is used to generally denote the longest dimension in this plane. However, it will be understood that in other examples the term ‘width’ may be interchangeable with the term ‘length’. For example, in other examples the agent distributor 202 may have a length that enables them to span the whole length of the support member 204 whilst the moveable carriage may move bi-directionally across the width of the support member 204.

In another example the agent distributor 202 does not have a length that enables it to span the whole width of the support member but are additionally movable bi-directionally across the width of the support member 204 in the illustrated x-axis. This configuration enables selective delivery of coalescing agent across the whole width and length of the support 204 using multiple passes. Other configurations, however, such as a page-wide array configuration, may enable three-dimensional objects to be created faster.

Although the description of agent distributor 202 is described herein as delivering coalescing agent, it is understood that in some examples, binder agent may be delivered by the agent distributor 202 rather than coalescing agent. Thus, the term “agent” is understood to encompass both coalescing agent and binder agent.

The system 200 may further comprise a build material distributor 224 to provide, e.g. deliver and/or deposit, successive layers of build material on the support member 204. Suitable build material distributors 224 may include, for example, a wiper blade and a roller. Build material may be supplied to the build material distributor 224 from a hopper or build material store. In the example shown the build material distributor 224 moves across the length (y-axis) of the support member 204 to deposit a layer of build material. As previously described, a layer of build material will be deposited on the support member 204, whereas subsequent layers of build material will be deposited on a previously deposited layer of build material. The build material distributor 224 may be a fixed part of the system 200, or may not be a fixed part of the system 200, instead being, for example, a part of a removable module. In some examples, the build material distributor 224 may be mounted on a carriage.

In some examples, the thickness of each layer may have a value selected from the range of between about 50 to about 300 microns, or about 90 to about 110 microns, or about 250 microns, although in other examples thinner or thicker layers of build material may be provided. The thickness may be controlled by the controller 210, for example based on the instructions 218.

In some examples, there may be any number of additional agent distributors and build material distributors relative to the distributors shown in FIG. 2. In some examples, the distributors of system 200 may be located on the same carriage, either adjacent to each other or separated by a short distance. In other examples, two or more carriages each may contain a distributor. For example, each distributor may be located in its own separate carriage. Any additional distributors may have similar features as those discussed earlier with reference to the coalescing agent distributor 202. However, in some examples, different agent distributors may deliver different coalescing agents and/or coalescence modifier agents, for example.

In the example shown the support member 204 is moveable in the z-axis such that as new layers of build material are deposited a predetermined gap is maintained between the surface of the most recently deposited layer of build material and lower surface of the agent distributor 202. In other examples, however, the support member 204 may not be movable in the z-axis and the agent distributor 202 may be movable in the z-axis.

The system 200 may additionally include an energy source 226 to apply energy to build material to cause the solidification of portions of the build material according to where coalescing agent has been delivered or has penetrated. In some examples, the energy source 226 is an infra-red (IR) radiation source, near infra-red radiation source, halogen radiation source, or a light emitting diode. In some examples, the energy source 226 may be a single energy source that is able to uniformly apply energy to build material deposited on the support 204. In some examples, the energy source 226 may comprise an array of energy sources.

In some examples, the energy source 226 is configured to apply energy in a substantially uniform manner to the whole surface of a layer of build material. In these examples the energy source 226 may be said to be an unfocused energy source. In these examples, a whole layer may have energy applied thereto simultaneously, which may help increase the speed at which a three-dimensional object may be generated.

In other examples, the energy source 226 is configured to apply energy in a substantially uniform manner to a portion of the whole surface of a layer of build material. For example, the energy source 226 may be configured to apply energy to a strip of the whole surface of a layer of build material. In these examples the energy source may be moved or scanned across the layer of build material such that a substantially equal amount of energy is ultimately applied across the whole surface of a layer of build material.

In some examples, the energy source 226 may be mounted on the moveable carriage.

In other examples, the energy source 226 may apply a variable amount of energy as it is moved across the layer of build material, for example in accordance with instructions 218. For example, the controller 210 may control the energy source to apply energy to portions of build material on which coalescing agent has been applied but to portions of build material on which coalescing agent has not been applied.

In further examples, the energy source 226 may be a focused energy source, such as a laser beam. In this example the laser beam may be controlled to scan across the whole or a portion of a layer of build material. In these examples the laser beam may be controlled to scan across a layer of build material. For example, the laser beam may be controlled to apply energy to those portions of a layer of on which coalescing agent is delivered.

The combination of the energy supplied, the build material, and the coalescing agent may be selected such that: i) portions of the build material on which no coalescing agent have been delivered do not coalesce when energy is temporarily applied thereto; ii) portions of the build material on which coalescing agent has been delivered or has penetrated coalesce when energy is temporarily applied thereto do coalesce.

The system 200 may additionally include a heater 230 to emit heat to maintain build material deposited on the support 204 within a predetermined temperature range. The heater 230 may have any suitable configuration. The heater 230 may have an array of heating units 232, as shown in FIG. 4. The heating units 232 may be each be any suitable heating unit, for example a heat lamp such as an infra-red lamp. The heating units 232 may have any suitable shapes or configurations such as rectangular as shown in FIG. 4. In other examples they may be circular, rod shaped, or bulb shaped, for example. The configuration may be optimized to provide a homogeneous heat distribution toward the area spanned by the build material. Each heating unit 232, or groups of heating units 232, may have an adjustable current or voltage supply to variably control the local energy density applied to the build material surface.

Each heating unit 232 may correspond to its own respective area of the build material, such that each heating unit 232 may emit heat substantially toward its own area rather than areas covered by other heating units 232. For example, each of the sixteen heating units 232 may heat one of sixteen different areas of the build material, where the sixteen areas collectively cover the entire area of the build material. However, in some examples, each heating unit 232 may also emit, to a lesser extent, some heat which influences an adjacent area.

The system 200 may additionally include a sensor 228 for detecting temperature, for example a point contactless temperature sensor such as a thermopile, or such as a thermographic camera. In other examples, the sensor 229 may include an array of fixed-location pyrometers which each capture radiation from a single area of the build material. In other examples, the sensor 229 may be a single pyrometer which may be operable to sweep or scan over the entire area of the build material. Other types of sensors may also be used.

The sensor 228 may be to capture a radiation distribution, for example in the IR range, emitted by each point of the build material across the area spanned by the build material on the support member 204. The sensor 228 may output the radiation distribution to the controller 210, which may generate spatial temperature distribution data comprising a temperature for each area across the build material based on known relationships, such as a black body distribution, between temperature and radiation intensity for the material used as the build material. For example, the radiation frequencies of the radiation distribution may have their highest intensities at particular values in the infra-red (IR) range. Each temperature may correspond to a particular area of the build material, wherein each of the areas collectively define an entire area of the build material print bed.

The sensor 228 may be oriented generally centrally and facing generally directly toward the build material, such that the optical axis of the camera targets the center line of the support member 204, to allow a generally symmetric capture of radiation from the build material. This may minimize perspective distortions of the build material surface, thus minimizing the need for corrections, and reducing errors in measured temperature values versus real temperature values. Additionally, the sensor 228 may be able to (1) capture the image over a wide region covering an entire layer of build material, for example by using suitable magnification, (2) capture a series of images of the entire layer which are later averaged, or (3) capture a series of images each covering a portion of the layer that together cover the entire layer. In some examples, the sensor 228 may be in a fixed location relative to the support member 204, but in other examples may be moveable if other components, when moving, disrupt the line of sight between the sensor 228 and the support member 204.

In some examples, an array of sensors 228 may be used. Each sensor 228 may correspond to its own respective area of the build material, such that each sensor 228 may perform measurements on its own area rather than areas corresponding to other sensors 228. In some examples, a 6×6 grid of 36 sensors may be used such that each sensor detects radiation in a respective one of 36 areas of the build material.

FIG. 5 is a flow diagram illustrating a method 300 of generating a three-dimensional object according to some examples. In some examples, the orderings shown may be varied, some elements may occur simultaneously, some elements may be added, and some elements may be omitted.

In describing FIG. 5, reference will be made to FIGS. 4, 6a-d. 7a-d, 8, and 9. FIG. 4 shows data representing a three-dimensional object according to some examples. FIGS. 6a-d show a series of cross-sectional side views of layers of build material according to some examples. FIGS. 7a-d show a series of top views of layers of build material according to some examples. A top view of layers along line 7a-7a of FIG. 6a is shown in FIG. 7a, and a cross sectional side view along lines 6a-6a of FIG. 7a is shown in FIG. 6a. A top view of layers along line 7c-7c of FIG. 6b is shown in FIG. 7c, and a cross sectional side view along lines 6b-6b of FIG. 7c is shown in FIG. 6b. A top view of layers along line 7c-7c of FIG. 6c is shown in FIG. 7c, and a cross sectional side view along lines 6c-6c of FIG. 7c is shown in FIG. 6c. A top view of layers along line 7d-7d of FIG. 6d is shown in FIG. 7d, and a cross sectional side view along lines 6d-6d of FIG. 7a is shown in FIG. 6d. FIGS. 8-9 show processing of temperature distribution data according to some examples.

At 302, data 400 representing the three dimensional object may be generated or obtained by the controller 210. “Data representing the three dimensional object” is defined herein to include any data defining the object from its initial generation as three dimensional object design data to its conversion into slice data representing slices of the object to be generated. The data 400 may be part of the instructions 218.

The three-dimensional object design data may represent a three-dimensional model of an object to be generated, and/or properties of the object (e.g. density, surface roughness, strength, and the like). The model may define the solid portions of the object. The three-dimensional object design data may be received, for example, from a user via an input device 220, as input from a user, from a software driver, from an application such as a computer aided design (CAD) application, or may be obtained from a memory storing default or user-defined object design data and object property data. The three-dimensional object design data may be processed by a three-dimensional object processing system to generate slice data representing slices of parallel planes of the model.

Each slice may define a portion of a respective layer of build material that is to be solidified by the additive manufacturing system. The slice data may undergo transformations from (1) vector slice data representing slices of the object in a vector format, to (2) contone slice data representing slices of the object in a bitmap or rasterized format, to (3) halftone slice data representing locations, portions, or patterns in which drops of agent are to be deposited on a layer of build material for each slice of the object, to (4) filter slice data representing the timing of when drops of agent are to be deposited in locations, portions, or patterns on a layer of build material for each slice of the object, e.g. using nozzles of an agent distributor.

At 304, a layer 402b of build material may be formed, as shown in FIGS. 6a and 7a. For example, the controller 210 may control the build material distributor 224 to form the layer 402b on a previously completed layer 402a on the support member 204 by causing the build material distributor 224 to move along the y-axis as discussed earlier. The completed layer 402a may include a solidified portion 408. Although a completed layer 402a is shown in FIGS. 6a-d for illustrative purposes, it is understood that 304 to 326 may initially be applied to generate the first layer 402a.

At 306, radiation from the layer 402b of build material may be detected by the sensor 228 or by an array of sensors, as discussed earlier. Measurements may be made for multiple different areas of the layer 402b. For example, a different measurement may be made for each of 36 areas on a 6×6 grid spanning the layer 402b. A single sensor 288 may perform this measurement, or a different sensor may perform a measurement for each of the 36 areas.

At 308, the controller 210 may receive data representing the radiation from the sensor 228. Based on the data representing the radiation, the controller 210 may determine spatial temperature distribution data 500 (FIG. 8) comprising respective temperatures for different areas (e.g. the 36 different areas) of the build material, according to the methods discussed earlier. In some examples, a processor of the sensor 228 may determine the spatial temperature distribution data 500 and the controller 210 may receive the data 500 rather than generating the data 500. Thus, the term “obtain” is intended to encompass examples including generating or receiving data. In some examples, the data representing the radiation may represent an image, and the controller 210 may process the data into a suitable image format, but in other examples the sensor 228 may provide the data to the controller 210 in a suitable image format.

In the example of FIG. 8, four central areas 502 of the spatial temperature distribution data 500 have a high temperature because the areas 502 may represent portions of the layer 402b that overlap the solidified portion 408 of layer 402a. The solidified portion 408 may have achieved higher temperatures than other portions of the layer 402a while the layer 402a was being processed, and heat may have flowed from the solidified portion to the portion of the layer 402b overlapping the center of the solidified portion 408. This may cause the high temperature areas 502 corresponding to portions of layer 402b.

The twelve middle areas 504 surrounding the four central areas 502 have a medium temperature that is lower than the high temperature of the four central areas 502. The twelve middle areas 504 may be colder than the four central areas 502 because they represent a portion of the layer 402b that overlap the periphery of the solidified portion 408 of layer 402a, and therefore do not receive as much heat from the solidified portion 408 as the portion of the layer 402b overlapping the center of the solidified portion 408.

The twenty outer areas 506 surrounding the twelve middle areas 504 have a low temperature that is lower than the medium temperature of the twelve middle areas 504. The twenty outer areas 506 may be colder than the areas 502 and 504 because they represent a portion of the layer 402b that overlap outer portions of the of layer 402a outside the solidified portion 408, and therefore do not receive as much heat from the solidified portion 408 as the portion of the layer 402b overlapping the center or periphery of the solidified portion 408.

At 310, the temperatures (e.g. 36 temperatures) of the spatial temperature distribution data 500 may be interpolated by the controller 210 to increase the resolution of the temperatures such that there are a greater number of temperatures each corresponding to a smaller area of the layer 402b. This may result in interpolated spatial temperature distribution data 508 as in FIG. 8. Interpolation is a method of determining new data points between a set of known data points. For example, an interpolation algorithm may be applied by the controller 210 to triangulate a planar set of data pixels having X and Y coordinates to determine a regular grid of interpolated data pixels representing interpolated temperatures in the temperature distribution. The interpolation algorithm may use linear or smooth polynomial interpolation, for example. In some examples, such as if the temperature sensor 228 did not sufficiently capture an image of the outer areas of the layer 402b, then grid points outside of the triangulation area may be extrapolated. In some examples, the spatial temperature distribution data 508 may have a grid of 992 data pixels (a 32×31 grid) representing 992 temperatures in 922 different areas of the layer 402b.

At 312, the interpolated spatial temperature distribution data 508 may be filtered using data representing the three-dimensional object by the controller 210.

In some examples, the data representing the three-dimensional object may comprise slice data 510 (FIG. 8) representing the previous layer 402a. The slice data 510 may include a representation of a slice 512 that is to be generated to form part of the object and a portion 514 which is not to form part of the slice 512. As shown in FIGS. 6a and 7a, solidified portion 408 may correspond to slice 512.

The controller 210 may implement a coordinate transformation instructions to map the spatial coordinates of the interpolated spatial temperature distribution data 508 to the spatial coordinates of the slice data 510. The known relationship between these coordinates may be stored in a memory of the controller 210. If the sensor 228 and support member 204 are movable relative to each other, then a plurality of relationships may be stored for each possible relative spatial configuration of the sensor 228 and the support member 204. The coordinate transformation instructions may correct for perspective error and may include a scale factor conversion between pixel distances of the interpolated spatial temperature distribution data 508 and the pixel distances of the slice data 510. In some examples, additional fine adjustment of the mapping may involve calibrating based on patterns provided in the build material which are detectable by the sensor 228 and therefore present in the interpolated spatial temperature distribution data 508. For example, the build area may be provided in locations, for example the corners of the build area, with patterns such as dot grids or interference patterns, and/or with delivery of a different-colored build materials to affect temperatures in those locations, to allow for detection by the sensor 228.

In some examples, the portion 518 of interpolated spatial temperature distribution data 502 corresponding to the slice 512 may be filtered by the controller 210. The may result in filtered spatial temperature distribution data 516 which contains unfiltered portion 520. The filtered portion 518 may be removed from the filtered spatial temperature distribution data 516 or ignored (e.g. designated as not to be used in subsequent operations such as heating).

By filtering the filtered portion 518 corresponding to where coalescing 404 was delivered on the layer 402a, more accurate and relevant temperature data may be used for applying heat at 314, since the temperatures of the filtered portion 518 are less relevant to temperature regulation involved in pre-heating at 326.

At 314, in some examples, the layer 402b of build material may be heated by the heater 230 to heat and/or maintain the build material within a predetermined temperature range. The predetermined temperature range may, for example, be below the temperature at which the build material would experience bonding in the presence of coalescing agent. For example, the predetermined temperature range may be between about 155 and about 170 degrees Celsius, or the range may be centered at about 160 degrees Celsius. In some examples, the predetermined temperature range may be understood herein to refer to a single target temperature such as 160 degrees Celsius. Pre-heating may help reduce the amount of energy that has to be applied by the energy source 226 to cause coalescence and subsequent solidification of build material on which coalescing agent has been delivered or has penetrated.

In some examples, the degree of heating on each area of the layer 402b may be modulated based on the temperatures of the filtered spatial temperature distribution data 516 in the unfiltered portion 520.

In some examples, the temperatures of unfiltered portion 520 may be averaged by the controller 210, and the heater 230 may provide sufficient heat to increase the temperature of the powder bed to a degree equal to the difference between the determined average temperature and the predetermined temperature range.

In other examples, multiple temperatures of the unfiltered portion 520 may be used directly as input for the heater 230. For example, if a particular area of the layer 402b corresponding to an area in the unfiltered portion 520 is relatively colder, then a greater degree of heat may be applied to cause the area of the layer 402b to reach the predetermined temperature range. If a particular area of the layer 402b corresponding to an area in the unfiltered portion 520 is relatively hotter, then a lesser degree of heat may be applied to cause the area of the layer 402b to reach the predetermined temperature range. In this way, different heating units 232 corresponding to different areas of the layer 402b may each provide different amounts of heat such that differential heating may be applied on different areas of the layer 402b. In this example, the heating applied to the portion of the layer 402b overlapping the solidified portion 408 may be sufficient to increase the temperature of the powder bed to a degree equal to the difference between a determined average temperature of temperatures of unfiltered portion 520 and the predetermined temperature range.

At 316, as shown in FIGS. 6b and 7b, coalescing agent 404 may be selectively delivered to the surface of portions of the layer 402b. As discussed earlier, the coalescing agent 404 may be delivered by agent distributor 202, for example in the form of fluids such as liquid droplets. In some examples, binder agent may be used rather than coalescing agent, as discussed earlier.

The selective delivery of the agent 404 may be performed in patterns on the portions of the layer 402b that the data representing the three-dimensional object may define to become solid to form part of the three-dimensional object being generated. “Selective delivery” means that agent may be delivered to selected portions of the surface layer of the build material in various patterns.

FIGS. 6c and 7c show coalescing agent 404 having penetrated substantially completely into the portions of the layer 402b of build material, but in other examples, the degree of penetration may be less than 100%. The degree of penetration may depend, for example, on the quantity of agent delivered, on the nature of the build material, on the nature of the agent, etc.

At 318, radiation from the layer 402b of build material may be detected by the sensor 228 or by an array of sensors, in a similar way as discussed earlier relative to 306.

At 320, the controller 210 may receive data representing the radiation from the sensor 228, and based on the data representing the radiation, the controller 210 may determine spatial temperature distribution data 600 (FIG. 9) comprising respective temperatures for different areas (e.g. the 36 different areas) of the build material, according to the methods discussed earlier. In some examples, a processor of the sensor 228 may determine the spatial temperature distribution data 600 and the controller 210 may receive the data 600 rather than generating the data 600. In some examples, the data representing the radiation may represent an image, and the controller 210 may process the data into a suitable image format, but in other examples the sensor 228 may provide the data to the controller 210 in a suitable image format.

In the example of FIG. 8, four central areas 602 of the spatial temperature distribution data 600 have a high temperature because the areas 602 may represent centers of portions of the layer 402b on which coalescing agent 404 have been delivered on layer 402b at 316. This may cause the high temperature areas 602 corresponding to the centers of portions of layer 402b with coalescing agent 404 because coalescing agent 404 may act as a light absorber which may generate heat.

The twelve middle areas 604 surrounding the four central areas 602 have a medium temperature that is lower than the high temperature of the four central areas 602. The twelve middle areas 604 may be colder than the four central areas 602 because the areas 604 represent portions of the layer 402b that are at the periphery of the portions of layer 402b where coalescing agent 404 has been delivered.

The twenty outer areas 606 surrounding the twelve middle areas 604 have a low temperature that is lower than the medium temperature of the twelve middle areas 604. The twenty outer areas 606 may be colder than the areas 602 and 604 because they represent a portion of the layer 402b on which coalescing agent 404 was not delivered and which therefore may not absorb as much light or generate as much heat as areas 602 and 604.

At 322, the temperatures (e.g. 36 temperatures) of the spatial temperature distribution data 600 may be interpolated by the controller 210 to increase the resolution of the temperatures such that there are a greater number of temperatures each corresponding to a smaller area of the layer 402b. This may result in interpolated spatial temperature distribution data 608 as in FIG. 9. This may be done in a similar way as discussed earlier relative to 310. In some examples, the spatial temperature distribution data 608 may have a grid of 992 data pixels (a 32×31 grid) representing 992 temperatures in 922 different areas of the layer 402b.

At 324, the interpolated spatial temperature distribution data 608 may be filtered using data representing the three-dimensional object by the controller 210.

In some examples, the data representing the three-dimensional object may comprise slice data 610 (FIG. 8) representing the current layer 402b. The slice data 610 may include a representation of a slice 612 that is to be generated to form part of the object and a portion 614 which is not to form part of the slice 612. As shown in FIGS. 6b-c and 7b-c, portions on which coalescing agent 404 is delivered may correspond to slice 612.

The controller 210 may implement a coordinate transformation instructions to map the spatial coordinates of the interpolated spatial temperature distribution data 608 to the spatial coordinates of the slice data 610, in a similar way as discussed earlier relative to 312.

In some examples, the portion 618 of interpolated spatial temperature distribution data 602 corresponding to the portions which are not part of the slice 612 to be generated may be filtered by the controller 210. The may result in filtered spatial temperature distribution data 616 which contains unfiltered portion 620. The filtered portion 618 may be removed from the filtered spatial temperature distribution data 516 or ignored (e.g. designated as not to be used in subsequent operations such as application of energy).

By filtering the filtered portion 618 corresponding to where coalescing 404 is not delivered on the layer 402b, more accurate and relevant temperature data may be used for applying energy at 326, since the temperatures of the filtered portion 618 are less relevant to temperature regulation involved in coalescence and solidification at 326.

At 326, a predetermined level of energy may be temporarily applied to the layer 402b of build material. In various examples, the energy applied may be infra-red or near infra-red energy, microwave energy, ultra-violet (UV) light, halogen light, ultra-sonic energy, or the like. The temporary application of energy may cause the portions of the build material on which coalescing agent 404 was delivered to heat up above the melting point of the build material and to coalesce. In some examples, the energy source 226 may be focused. In some examples in which the energy source 226 is focused, the energy source 226 may cause coalescence of build material without use of coalescing agent 404, but in other examples coalescing agent 404 may be used. In other examples, the energy source 226 may be unfocused, and the temporary application of energy may cause the portions of the build material on which coalescing agent 404 has been delivered or has penetrated to heat up above the melting point of the build material and to coalesce. For example, the temperature of some or all of the layer 402b may achieve about 220 degrees Celsius. Upon cooling, the portions having coalescing agent 404 may coalesce may become solid and form part of the three-dimensional object being generated, as shown in FIGS. 6d and 7d.

As discussed earlier, one such solidified portion 408 may have been generated in a previous iteration. The heat absorbed during the application of energy may propagate to the previously solidified portion 408 to cause part of portion 408 to heat up above its melting point. This effect helps creates a portion 410 that has strong interlayer bonding between adjacent layers of solidified build material, as shown in FIGS. 6d and 7d.

In some examples, the energy may not be applied, for example if binder agent is used, or if the coalescing agent 404 is to cause coalescence and solidification of build material without use of the energy source 226.

In some examples, the degree of energy applied on each area of the layer 402b may be modulated based on the temperatures of the filtered spatial temperature distribution data 616 in the unfiltered portion 620 corresponding to the slice 612 to be generated.

In some examples, the temperatures of unfiltered portion 620 may be averaged by the controller 210, and the energy source 226 may provide sufficient energy to increase the temperature of the powder bed to a degree equal to the difference between the determined average temperature and a predetermined temperature range (e.g. range of multiple temperatures or single target temperature) at which coalescence or solidification may occur where coalescing agent 404 is delivered.

In other examples, multiple temperatures of the unfiltered portion 620 may be used directly as input for the energy source 226. For example, if a particular portion of the layer 402b having coalescing agent 404 and corresponding to an area in the unfiltered portion 620 is relatively colder, then a greater degree of energy may be applied to cause the area of the layer 402b to reach the predetermined temperature range for coalescence and solidification. If a particular portion of the layer 402b having coalescing agent 404 and corresponding to an area in the unfiltered portion 620 is relatively hotter, then a lesser degree of energy may be applied to cause the area of the layer 402b to reach the predetermined temperature range for coalescence and solidification. The selective delivery of energy may be achieved in these examples by a focused energy source or by an unfocused energy source that can vary the degree of energy applied in different locations. In this example, the energy applied to the portion of the layer 402b outside where coalescing agent 404 has been delivered may be sufficient to increase the temperature of the powder bed to a degree equal to the difference between a determined average temperature of temperatures of unfiltered portion 620 and the predetermined temperature range.

After a layer of build material has been processed as described above in 304 to 326, new layers of build material may be provided on top of the previously processed layer of build material. In this way, the previously processed layer of build material acts as a support for a subsequent layer of build material. The process of 304 to 324 may then be repeated to generate a three-dimensional object layer by layer.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

1. A system for generating a three-dimensional object, the system comprising:
at least one sensor to detect temperatures of a current layer of build material on a support member, each of the temperatures corresponding to a respective area of the current layer; and
a controller to:
based on data representing the three-dimensional object, filter a subset of the temperatures from spatial temperature distribution data comprising the temperatures; and
control a degree of heat or energy applied to the current layer based on the filtered spatial temperature distribution data.

2. The system of claim 1 wherein the controller is to interpolate the spatial temperature distribution data before it is to filter the spatial temperature distribution data.

3. The system of claim 1 wherein the data representing the three-dimensional object is slice data representing a slice of the three-dimensional object that is to be generated using the current layer.

4. The system of claim 1 wherein the data representing the three-dimensional object is slice data representing a slice of the three-dimensional object that is to be generated using a previous layer that is to be formed before the current layer.

5. The system of claim 1 further comprising an agent distributor to selectively deliver an agent to a portion of the current layer of the build material in a pattern, wherein the controller is to control the agent distributor to selectively deliver the coalescing agent to the portion of the current layer in a pattern derived from the data representing the three-dimensional such that the portion is to solidify to form a slice in accordance with the pattern.

6. The system of claim 5 wherein the agent comprises a coalescing agent.

7. The system of claim 6 further comprising an energy source to apply the energy to the current layer of build material to cause the portion of the current layer to coalesce and solidify, wherein the controller is to control the energy source to apply the energy to the current layer to cause the portion to coalesce and solidify in the pattern.

8. The system of claim 7 wherein the controller is to control the degree of the energy applied to the current layer based on the filtered spatial temperature distribution data.

9. The system of claim 1 further comprising a heater to apply the heat to the current layer of build material, wherein the controller is to apply the heat to control the heater to pre-heat the current layer.

10. The system of claim 9 wherein the controller is to control the degree of the heat applied to the current layer based on the filtered spatial temperature distribution data.

11. The system of claim 1 wherein the controller is to average the temperatures of the filtered spatial temperature distribution data to generate an average temperature, wherein the controller is to control the degree of the heat or the energy applied to the current layer based on the average temperature of the filtered spatial temperature distribution data.

12. The system of claim 1 wherein the subset of temperatures correspond to an area of the current layer that is to overlap an area of a previous layer on which coalescing agent is to be delivered.

13. The system of claim 1 wherein the subset of temperatures correspond to an area of the current layer on which coalescing agent is not to be delivered.

14. A non-transitory computer readable storage medium including executable instructions that, when executed by a processor, cause the processor to:
obtain spatial temperature distribution data representing temperatures, each of the temperatures based on a respective measurement of a respective area of the layer of build material on a support member, the build material to be used for generating a three-dimensional object;
interpolate the spatial distribution data;
filter some of the temperatures from the interpolated spatial temperature distribution data using slice data representing a slice of the three-dimensional object; and
control heat or energy applied to the layer using the filtered spatial distribution data.

15. A method comprising:
forming a layer of build material on a support member;
measuring temperatures of a layer of build material on a support member, each of the temperatures corresponding to a respective area of the layer; and
filtering part of the spatial temperature distribution data using data representing a three-dimensional object; and
selectively depositing agent onto a portion of the layer of the build material;
controlling heat or energy applied to the layer using the filtered spatial distribution data, wherein the heat is for heating the layer before depositing the agent, and the energy is for causing the portion to coalesce and solidify to form a slice of the three-dimensional object.
